(19) United States
(12) Patent Application Publication
(10) Pub. No.: US 2013/0278728 A1
(43) Pub. Date: Oct. 24, 2013

(54) COLLABORATIVE CROSS-PLATFORM VIDEO CAPTURE

(71) Applicants: Michelle X. Gong, Sunnyvale, CA (US); Wei Sun, San Jose, CA (US)

(72) Inventors: Michelle X. Gong, Sunnyvale, CA (US); Wei Sun, San Jose, CA (US)

(21) Appl. No.: 13/977,267

(22) PCT Filed: Dec. 16, 2011
(86) PCT No.: PCT/US11/65400

§ 371 Date: Jun. 28, 2013

(51) Int. Cl. H04N 13/02

(52) U.S. Cl. CPC H04N 13/0296
USPC 348/47

(57) ABSTRACT

Systems, devices and methods are described including determining a clock offset between one video capture device and another video capture device, capturing a first video sequence of a scene using the first video capture device, sending a start command to the other video capture device, sending a stop command to the other video capture device, sending a video file transfer command to the other video capture device, and receiving a second video sequence of the scene that was captured by the other video capture device in response to the start and stop command. The clock offset may then be used to synchronize the first video sequence to the second video sequence.

### BACKGROUND

Currently, many mobile devices such as smart phones or tablets are equipped with video-capable cameras. Generally such capture devices are used by a single user and each device captures image and/or video content independently. Some applications, such as three-dimensional (3D) modeling of at scene or the creation of motion parallax 3D perception from multiple two-dimensional (2D) images of the scene, require capturing images of the scene from multiple angles and perspectives and then combining and processing these images to compute the 3D information of the scene. Unfortunately, an independent capture framework where multiple capture devices are not synchronized works well only if a scene to be captured exhibits little motion and the difference in capture time does not matter. Such frameworks do not work well for scenes that exhibit motion.

Implementing synchronized zed video capture using multiple independent devices without modifying the device's hardware is a challenging problem. For example, it may be desirable to have timing synchronization accuracy of less than 16 milliseconds. However, due to various factors such as the delay/jitter introduced by a platform, operating system, and/or application software, different capture devices may have significant delay variation in capture time at different capture stages. Current synchronization solutions either have insufficient timing accuracy (e.g., Network Timing Protocol (NTP)) or require significant platform changes to support existing synchronization protocols (e.g., the 802.11v and 802.1 AS protocols).

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example scheme;

FIG. 2 is an illustrative diagram of an example device;

FIG. 3 is a flow diagram illustrating an example video capture process;

FIG. 4 is an illustrative diagram of an example control message;

FIG. 5 is an illustrative diagram of an example three-way handshake scheme;

FIG. 6 is a flow diagram illustrating an example synchronization process;

FIG. 7 is an illustrative diagram of an example metadata message format;

FIG. 8 is an illustrative diagram of an example video file format;

FIG. 9 is an illustrative diagram of an example timing scheme;

FIG. 10 is an illustrative diagram of an example system; and

FIG. 11 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include am medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

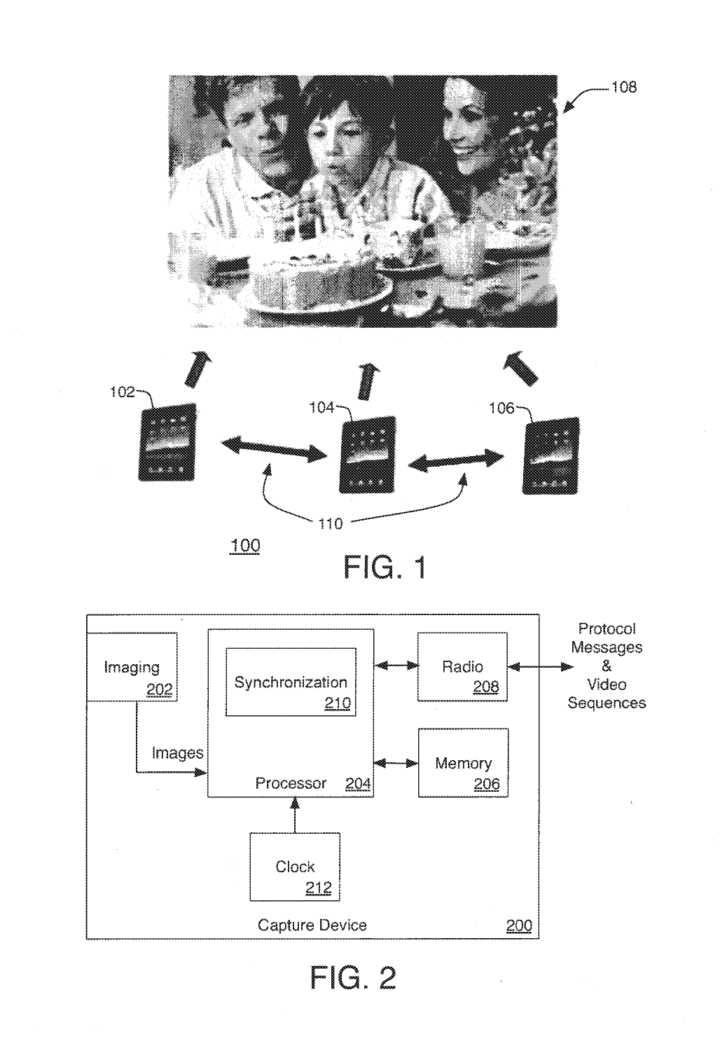

FIG. 1 illustrates an example collaborative video capture scheme 100 in accordance with the present disclosure. In various implementations, scheme 100 may include multiple video capture devices 102, 104 and 106 arranged to capture video of a three-dimensional (3D) scene 108. In various implementations, to collaboratively capture video of scene 108, capture devices 102, 104 and 106 may employ control and/or synchronization protocols in accordance with the present disclosure that will be described in greater detail below. In doing so, devices 102, 104 and 106 may exchange protocol messages 110. Further, in accordance with the present disclosure, each of device 102, 104 and 106 may use its own free running clock (not shown) to generate various time stamps and may include one or more of those time stamps in protocol messages 110 as will also be explained in greater detail below.

In various implementations, a capture device in accordance with the present disclosure may be any type of device such as various consumer electronic (CE) devices including video capable cameras, mobile computing systems (e.g., tablet computers or the like), mobile and/or handheld communication devices (e.g., smart phones or the like), and so forth, that are a capable of capturing video image sequences of scene 108. Although FIG. 1 appears to depict devices 102, 104 and 106 as being similar to each other, the present disclosure is not limited to schemes employing similar and/or identical capture devices or device platforms. Thus, for example, devices 102, 104 and 106 may be dissimilar devices (e.g., devices 102 and 104 may be smart phones, while device 106 may be a tablet computer, and so forth). In various implementations, devices 102, 104 and 106 may capture video sequences having a substantially similar or different image resolution and/or frame rate.

FIG. 2 illustrates a capture device 200 in accordance with the present disclosure where device 200 may be for example, any one of capture devices 102, 104 and 106 of scheme 100. Device 200 includes an imaging module 202 that captures video images under the control of and provides the video images to, a processor 204. In various implementations, imaging module 202 may include any type of imaging array and associated logic that is capable of capturing video images. In various implementations, processor 204 may be any type of processor such as a media processor, graphics processor, digital signal processor or the like that is capable of receiving a video sequence from module 202 and that is capable of processing that video sequence as described herein.

Device 200 also includes memory 206, a radio module 208, a synchronization module 210, and a clock module 212. In various implementations, synchronization module 210 may be associated with a collaborative video capture application (not shown) and may be implemented, for example, by software code executed by processor 204. In various implementations, synchronization module 210 may implement control and synchronization protocols in accordance with the present disclosure. In doing so, synchronization module 210 may use radio module 208 to wirelessly transmit protocol messages to other capture devices of scheme 100 using well-known wireless communications schemes such as WiFi or the like. Radio 208 may also wirelessly receive protocol messages from other capture devices and may that convey those messages to synchronization module 210. Further, synchronization module 210 may also use radio 208 to wirelessly transmit video sequences captured by imaging module 202 (and which may be encoded by processor 204 prior to transmission) to other capture devices of scheme 100. Radio 208 may also wirelessly receive video sequences from other capture devices and may then convey that video to synchronization module 210.

In accordance with the present disclosure, and as will be described in greater detail below, synchronization module 210 may insert timing data (such as time stamps), generated in response to a clock signal provided by clock module 212, into the various protocol messages sent to other video capture devices. In addition, synchronization module 210 may receive timing data (such as time stamps) associated with protocol messages received from other video capture devices where that timing data was generated by the other devices. In various implementations, synchronization module 210 may store timing data that has been generated internally to device 200 or that has been received from other video capture devices in memory 206. In various implementations, as will be explained in greater detail below, synchronization module 210 may use the timing data to determine a clock offset between clock signal of device 200 (as generated by clock module 212) and the clock signals of other image capture devices.

Radio module 208 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio module 208 may operate in accordance with one or more applicable standards in any version. In addition, memory 206 may be implemented as a volatile memory device such as, but not limited to, a Random Access Memory (RAM) Dynamic Random Access Memory (DRAM), or Static RAM (SRAM). In other implementations, memory 206 may be non-volatile memory such as flash memory.

Returning to discussion of FIG. 1, in accordance with the present disclosure a user of any of capture devices 102, 104 and 106 may start a collaborative video capture application on that device. In response, the capture device may automatically initiate control and/or synchronization protocols that, using protocol messages 110, may provide synchronization information including time stamps to each of devices 102, 104 and 106. Further, in accordance with the present disclosure, each of devices 102, 104 and 106 may capture video of scene 108, may exchange the captured video with each other, and may use the synchronization information to synchronize the various video sequences.

While scheme 100 illustrates three video capture devices 102, 104 and 106 the present disclosure is not limited to any specific number of video capture devices when implementing collaborative video capture schemes and/or undertaking collaborative video capture processes in accordance with the present disclosure. Thus, for example, in various implementations, collaborative video capture schemes in accordance with the present disclosure may include two or more video capture devices.

Further, as will be explained in greater detail below, collaborative video capture schemes in accordance with the present disclosure may include video capture devices implementing master/slave or server/client schemes. In other implementations, as will also be explained in further detail below, collaborative video capture schemes in accordance with the present disclosure may include video capture devices implementing peer-to-peer schemes.

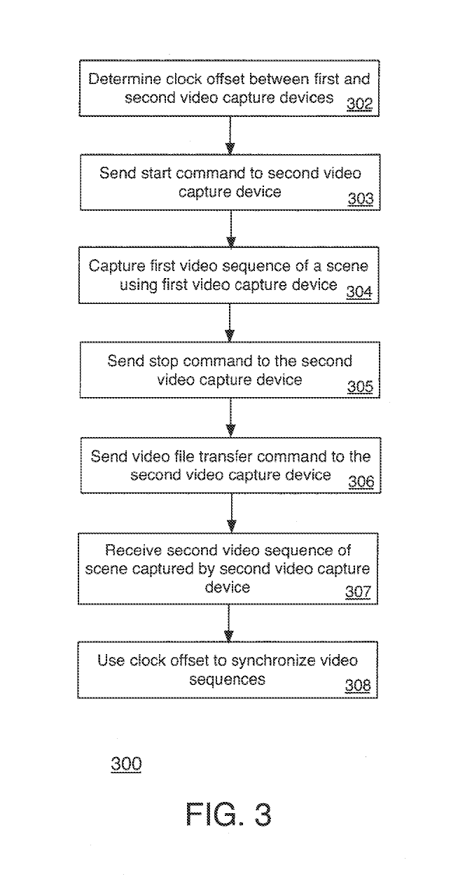

FIG. 3 illustrates a flow diagram of an example process 300 for collaborative video capture according to various implementations of the present disclosure. Process 300 may include one or more operations, functions or actions as illustrated by one or more of blocks 302, 303, 304, 305, 306, 307 and 308 of FIG. 3. By way of non-limiting example, process 300 will be described herein with reference to example scheme 100 of FIG. 1 and to example video capture device 200 of FIG. 2.

Process 300 may begin at block 302 where a clock offset may be determined between first and second video capture devices. In various implementations, block 302 may involve a collaborative video capture application on device 200 automatically implementing both a control process using a control protocol and a synchronization process using a synchronization protocol. In accordance with the present disclosure, a control process for collaborative video capture may allow one video capture device to act as a master device in order to trigger other video capture slave devices on the same wireless network to capture video sequences automatically without user intervention at the slave devices.

In accordance with the present disclosure, a control protocol may define at least four control messages including a video trigger message, a start message, a stop message, and a video file transfer message. However, the present disclosure is not limited to only four control messages and additional control messages may be defined. In various implementations, a video trigger control message may instruct a slave capture device to initiate a collaborative video capture application that may perform a synchronization process in accordance with the present disclosure. In various implementations, a start control message may include a start command that instructs a slave capture device to start capturing a video sequence. In various implementations, a stop control message may include a stop command that instructs a slave capture device to stop capturing the video sequence. In various implementations, a video file transfer message may include a video file transfer command that instructs a slave capture device to transfer a video file including the captured video sequence to the master capture device. In various implementations, the video file including the captured video sequence may be associated with and accompanied by metadata that includes a start time stamp specifying the start time of the captured video sequence, where the slave capture device generated the start time stamp using its own internal clock module.

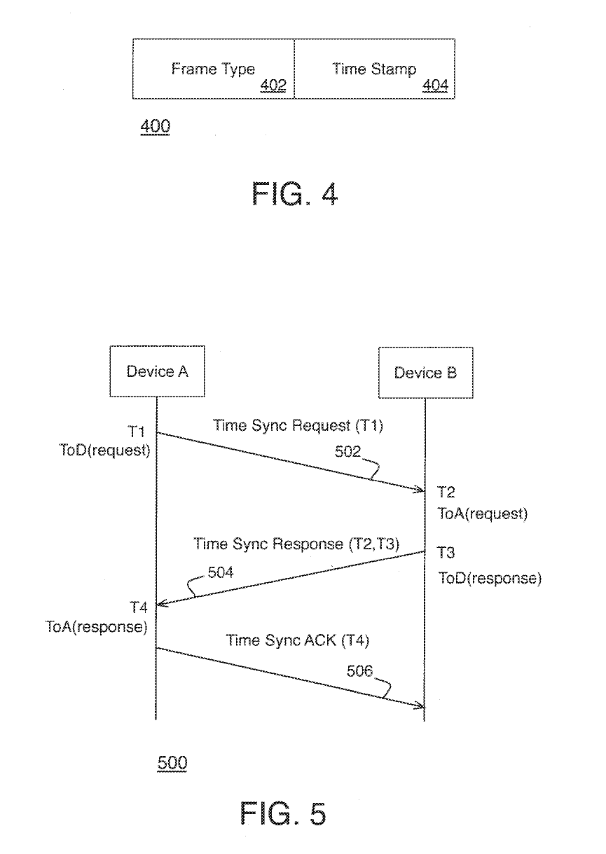

In various implementations, control messages may include two fields. For instance, FIG. 4 depicts an example control message format 400 including a frame type field 402 that identifies the message type (e.g., video trigger, start, stop, or video file transfer) and that acts as the corresponding command (e.g., video trigger command, start command, stop command, or video file transfer command) and timing data in the form of a ToD time stamp field 404 that specifies the Time of Departure (ToD) of the frame. For example, synchronization module 210 may use radio module 208 to convey control messages to other video capture devices and may generate the timing data appearing in the ToD time stamp field 404 of those messages using a clock signal received from clock module 212. Message format 400 is provided herein for illustration purposes, and various control message formats or schemes may be employed, the present disclosure not being limited to any particular control message format or scheme.

In various implementations, a synchronization protocol may be used at block 302 to determine a clock offset as a mechanism to achieve synchronization between two video capture devices. Thus, rather than modifying a video capture device's clock to match another device's clock, synchronization protocols in accordance with the present disclosure may permit a video capture device to determine the clock offset between its own dock signal and the clock signal of one or more other video capture devices.

In accordance with the present disclosure, a clock offset measurement or synchronization protocol may define at least three synchronization messages including a time sync request, a time sync response, and a time sync acknowledgment (ACK). However, the present disclosure is not limited to three synchronization messages and additional control messages may be defined. In various implementations, synchronization messages may have a frame format similar to that set forth in FIG. 4. Further, in various implementations, undertaking a synchronization process at block 302 may include performing a three-way handshake scheme 5110 as depicted in FIG. 5 using the three synchronization messages.

In scheme 500, a video capture device (device A) may transmit a time sync request message 502 that includes timing data (T1) specifying the Time of Departure in the form of a ToD time stamp. For example, synchronization module 210 may use radio module 208 to transmit message 502 to another video capture device (device B) and may include a ToD time stamp generated using a clock signal received from clock module 212. In Various implementations, timing data T1 may specify the departure time of message 502 and may be expressed as a time value having units of microseconds.

Upon receiving the time sync request message 502, device B may record timing data (T2) specifying the Time of Arrival (ToA) of message 502. Device B may generate timing data (T2) using its own synchronization and clock module. Device B may then transmit a time sync response message 504 to device A, where message 504 includes T2 as well as additional timing data (T3) specifying the ToD of message 504. In various implementations, timing data 12 and 13 may be time values having units of microseconds.

Upon receiving the time sync response message 504, device A may record timing data (T4) specifying the ToA of message 504. Device A may then transmit a time sync ACK message 506 that includes T4 to device B. In various implementations, both devices A and B may record and store timing data T1, T2, T3 and T4. For example, device 200 may store the time values corresponding to time stamps T1, T2, T3 and T4 in memory 206. By doing so, devices A and B of scheme 500 may determine a clock offset value between the device's internal clock signal and the other device's clock signal as will be explained in greater detail below.

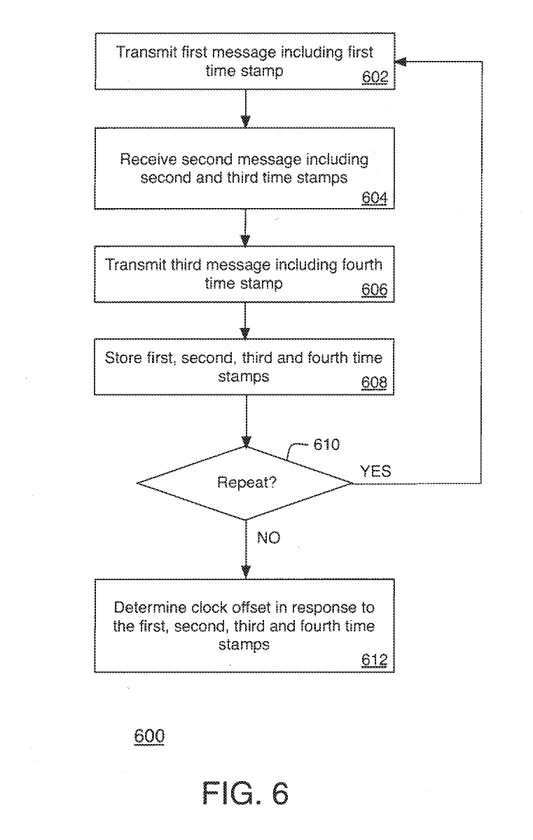

A synchronization process in accordance with the present disclosure undertaken at block 302 may employ a three-way handshake scheme (e.g., as depicted in FIG. 5) to generate timing data (e.g., time stamps T1, T2, T3 and T4) that may be used to determine a clock offset. For instance, FIG. 6 illustrates a flow diagram of an example synchronization process 600 according to various implementations of the present disclosure. Process 600 may include one or more operations, functions or actions as illustrated by one or more of blocks 602, 604, 606, 608, 610 and 612 of FIG. 6. By way of non-limiting, example, process 600 will be described herein with reference to example scheme 100 of FIG. 1, to example video capture device 200 of FIG. 2, and to example three-way handshake scheme 500 of FIG. 5.

Process 600 may begin at block 402 where a first message, including a first time stamp, may be transmitted. For example, block 602 may correspond to the initiation of a three-way handshake between two video capture devices, such as devices 102 and 104. For example, block 602 may be undertaken automatically when a user of device 102 invokes collaborative video capture by, for example, starting a software application on device 102. In doing so, device 102 may send a video trigger command to device 104 instructing device 104 to start a corresponding collaborative video capture application and informing device 104 that a synchronization procedure is being initiated. For instance, referring to example scheme 500, block 602 may correspond to device 102 (e.g., device A of scheme 500) sending a time sync request message 502, including the T1 time stamp, to device 104 (e.g., device B of scheme 500). As noted above, the time stamp T1 may represent the ToD of the first message from device 102.

At block 604, a second message may be received where the second message includes a second time stamp and a third time stamp. For instance, block 604 may correspond to device 102 receiving, from device 104, a time sync response message 504 including the T2 and T3 time stamps. As noted above, time stamp T2 may represent the ToA of the first message at device 104 and time stamp T3 may represent the ToD of the second message from device 104.

Process 600 may continue at block 606 where a third message, including a fourth time stamp, may be transmitted. For instance, block 606 may correspond to device 102 sending a time sync ACK message 506, including the T4 time stamp, to device 104. As noted above, the time stamp T4 may represent the ToD of the fourth message from device 102.

At block 608, the first, second, third and fourth time stamps may be stored. For example, block 608 may involve device 102 using synchronization module 210 to store the respective time values corresponding to the T1, T2, T3 and T4 time stamps in memory 206. For example, in various implementations, when undertaking each of blocks 602, 604 and 606, device 102 may record the T1, T2, T3 and T4 time stamps by writing the corresponding time values to memory 206.

Process 600 may continue at block 610 where a determination may be made as to whether to repeat blocks 602-608. For example, in various implementations, blocks 602-608 may be undertaken multiple times so that process 600 may loop repeatedly through blocks 602-610 and, at each instance of block 608, a corresponding set of T1, T2, T3 and T4 time stamps may be stored. In some implementations, blocks 602-608 may be undertaken ten times or more and the corresponding sets of time stamp values may be stored for later use as described below. For example, a collaborative video capture application initiated at block 602, may perform the determination of block 610 based on predetermined number of times that blocks 602-606 (corresponding to a three-way handshake scheme) are to be undertaken.

If it is determined at block 610 that blocks 602-608 are not to be repeated, then process 600 may conclude at block 612 where a clock offset may be determined in response to the first, second, third and fourth time stamps. In various implementations, block 610 may involve synchronization module 210 of device 102 performing a series of calculations using the time values stored as a result of undertaking blocks 602-610.

In various implementations, synchronization module 210 may undertake block 612 by retrieving time values from memory 206 and using the time values to determine a clock offset value between device 102 and device 104 using the following expression:

ClockOffset_{dev1}=[(T2−T1)−(T4−T3)]/2 (Eq. 1)

In various implementations, the value of each of the various time stamps T1, T2, T3 and T4 may correspond to different factors. For example, the value of T1 may be a function of the clock signal of device 102, the value of T2 may be a function of the clock signal of device 104 and the frame delay corresponding to the interval between the transmission of the first message by device 102 and its receipt by device 104, the value of T3 may be a function of the clock signal of device 104, and the value of T4 may be a function of the clock signal of device 102 and the frame delay corresponding to the interval between the transmission of the second message by device 104 and its receipt by device 102. Thus, in accordance with the present disclosure, a clock offset value corresponding to the offset between the clock signals of a first video capture device and a second video capture device may be determined at the first video capture device using Eq. 1.

In various implementations, synchronization module 210 may retrieve multiple sets of values corresponding to the T1, T2, T3 and T4 time stamps, apply Eq. 1 to each set of T1, T2, T3 and T4 values to compute a clock offset, and apply a smoothing function to the resulting clock offset values to account for platform and/or network jitter. For instance, various known smoothing algorithms may be applied to smooth the clock offset values. For example, in various implementations, a smoothing algorithm including a function of form

y(i+1)=A*x(i+1)+1−A)*y(i) (Eq. 2)

may be applied, where x(i+1) is the (i+1)th clock offset result computed from the (i+1)th set of T1, T2, T3 and T4 values, y(i) is the (i)th smoothed clock offset, and A is a variable weighting factor having values greater than Zero and less than one. For example, more recent clock offset values may be given greater weight using larger values of A (e.g., A=0.8). The present disclosure is not however, limited to any particular data processing techniques, such as the application of smoothing function of Eq. 2. Thus, for example, in other implementations, averaging may be applied to the results of Eq. 1 using an averaging window to restrict the averaging to, for example, a last K samples.

While process 600 has been described herein from the perspective of actions undertaken by one device of a pair of collaborating video capture devices (e.g., the device initiating the scheme 500 by transmitting a video trigger command to another video capture device), the other video capture device may also undertake storing the time stamp values (block o08) and determining a clock offset (block 612) in a peer-to-peer arrangement. Thus, in various implementations, the synchronization module 210 of the second video capture device (e.g., device 104) may determine a clock offset between its clock signal and the clock signal of the first video capture device (e.g., device 102) using the following expression:

ClockOffset_{dev2}=[(T4−T3)−(T2−T1)]/2 (Eq. 3)

Thus, upon completion of a timing synchronization process in accordance with the present disclosure, both video capture devices may learn about the timing offset between the clock signals of two devices.

Returning to discussion of FIG. 3, after determining the clock offset at block 302, process 300 may continue at blocks 303 and 304 where a first video capture device may issue a start command (e.g., a start control message) to a second video capture device at block 303 while the first video capture device may capture a first video sequence of a scene at block 304. For example, in various implementations after undertaking a clock offset measurement or synchronization protocol (e.g., scheme 500) at block 302, device 102 may undertake block 303 by issuing a start command (e.g., a start control message) to device 104 while simultaneously or closely thereafter capturing a video sequence of scene 108 at block 304. Upon receiving the start command from the first video capture device, the second video capture device may capture a second video sequence of the scene. For example, in various implementations, after receiving a start command from device 102, device 104 may capture a video sequence of scene 108.

At block 305, a stop command may be sent to the second video capture device. For example, device 102 in maY undertake block 305 by issuing a stop command (e.g., a stop control message) to device 104 instructing device 104 to stop capturing the video sequence that it started capturing in response to the start command received as a result of block 303.

Subsequently, at block 306, a video file transfer command may be sent to the second video capture device. For example, having instructed device 104 to stop capturing video at block 305, device 102 may undertake block 306 by issuing a video file transfer command (e.g., a video file transfer control message) to device 104 instructing device 104 to provide the video sequence that it captured in response to the start (block 303) and stop (block 305) commands.

Process 300 may continue at block 307 where a second video sequence of the scene as captured by second video capture device may be received by the first video capture device. For example, in various implementations, after capturing a second video sequence of scene 108 in response to the start (block 303) and stop (block 305) commands, device 104 may record a start time of that video using its own clock signal, and may then send, in response to the video file transfer command (block 306), that video sequence and corresponding start time to device 102 where it may be received at block 307.

In accordance with the present disclosure, when a video file is transferred from one device to another device, an associated metadata message may be transferred first. In various implementations, the metadata message may contain the capture start, time (e.g., in milliseconds) and various context information such as a gyroscopic data, device orientation, and so forth, associated with the device that generated the video file. Such context information may be useful for post-processing purposes including aligning the video frames and compiling the raw data into processed, data.

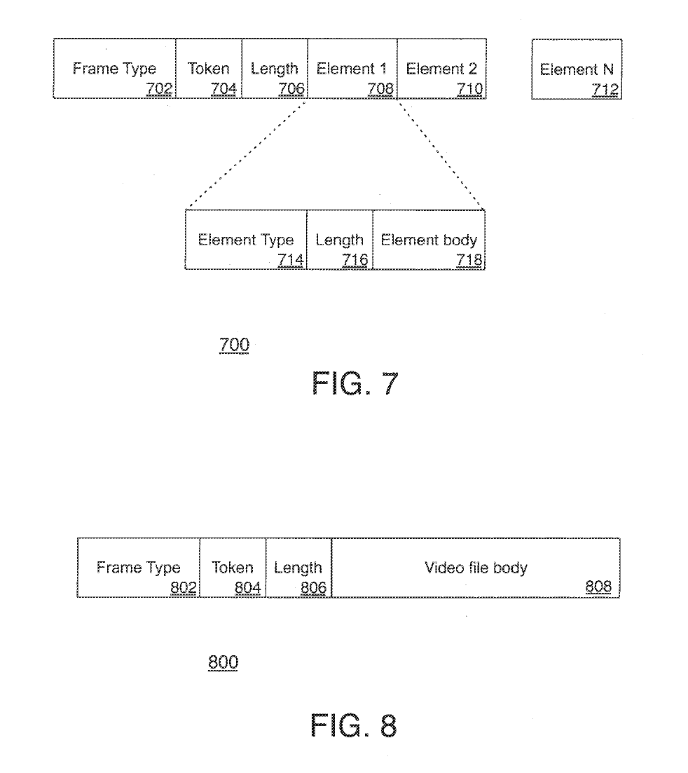

For example, FIG. 7 depicts an example metadata message format 700 and FIG. 8 depicts an example video tile format 800. As shown in FIG. 7, metadata message format 700 may include a frame type field 702 that identifies the message as video metadata, a token field 704, such as a counter, that associates the metadata with a particular video file, a length field 706 that specifies the message body length (e.g., in octets), and one or more elements, 708, 710, . . . , 712 that contain different types of video metadata. In turn, each element field may include an element type field 714, a length field 716 that specifies the element body length (e.g., in octets) and an element body field 718. The element type field 714 may specify the type of video metadata appearing in body field 718. In accordance with the present disclosure, video metadata provided by metadata message 700 may include, but is not limited to, a timing-offset value (e.g., in milliseconds), a video capture start time value (e.g., in milliseconds), and device orientation and/or location data such as accelerometer data, gyroscopic data, light data, magnetite data, longitude and latitude data, and so forth. Format 700 is provided herein for illustration purposes, and various metadata message formats or schemes may be employed, the present disclosure not being limited to any particular video metadata message format or scheme.

As shown in FIG. 8, video file format 800 may include a frame type field 802 that identifies format 800 as a video file frame, a token field 804 that has a same value as a token field of a corresponding metadata message (e.g., token field 704 of FIG. 7), a length field 806 that specifies the video file body length (e.g., in octets), and a video file body field 808 that contains the video data. Format 800 is provided herein for illustration purposes, and various file formats or schemes may be employed, the present disclosure not being limited to any particular video file format or scheme. For example, a video file may be broken into multiple frames and/or more sophisticated frame formatting schemes may be employed.

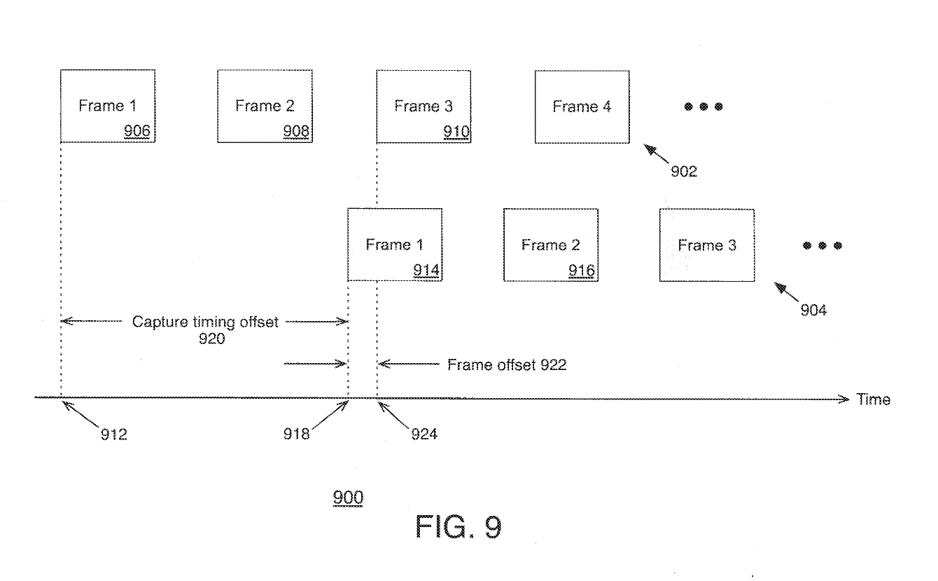

Process 300 may conclude at block 308 where the clock offset may be used to synchronize the first and second video sequences. For example, FIG. 9 illustrates a hypothetical timing scheme 900 for example first and second video sequences 902 and 904, respectively. In scheme 900, sequence 902 may represent a video sequence captured by the first video capture device at block 304 while sequence 904 may represent a video sequence captured by the second video capture device and received by the first video capture device at block 307.

As shown in scheme 900, sequence 902 may include a series of image frames 906, 908, 910 and so on, where a beginning of the first frame 906 may correspond to a start time 912 of sequence 902. Similarly, sequence 904 may include a series of image frames 914, 916 and so on, where a beginning of the first frame 914 may correspond to a start time 918 of sequence 904. Continuing the example from above, device 102 may employ synchronization module 110 to synchronize sequence 902 with sequence 904 using the clock offset determined at block 302. Thus, in various implementations, knowing the start time 918 of sequence 904 (generated using the clock signal of device 104 and provided to device 102 at block 307), the start time 912 of sequence 902 (generated by device 102's clock signal) and the clock offset determined at block 302, device 102 may determine a capture timing offset 920 to aid in synchronizing the two video sequences at block 308.

In various implementations, assuming the frame rates of sequences 902 and 904 are the same, once device 102 determines the capture timing offset 920, device 102 also may determine at block 308 the appropriate start time of the video sequence 902 and/or 904 to minimize or reduce a frame offset 922 between sequence 902 and 904. For example, device 102 may first find frame 910 of sequence 902 that is closest in time to the start time 918 of sequence 904, and may then use the time 924 of frame 910 as the start time of sequence 902. In addition, when undertaking block 308, device 102 may discard frames 906 and 908 of sequence 902. However, the present disclosure is not limited to synchronizing video sequences having a same frame rate. Thus, in various implementations, if the two sequences have different frame rates but the frame rate of each sequence is a known constant, the capture time of each image in a sequence may be computed from the known start time and frame rate. Moreover, if the frame rate of a sequence is not constant and/or known but each image frame in the sequence is individually time stamped, the per-image time stamps may be used for synchronization.

Thus, in accordance with the present disclosure, because every frame recorded at a device is time-stamped using the local clock and because the master device (e.g., device 102) knows the clock offset between it and the slave device (e.g., device 104) as well as the capture timing offset, the master device may match video frames taken around the same time. In various implementations, synchronized video sequences obtained via process 300 may be used to enable various applications such as the video three-dimensional (3D) reconstruction or modeling of scene 108, the creation of motion parallax 3D perception of scene 108, and so forth. Further, by implementing process 300, it may be possible in various embodiments to obtain a timing synchronization accuracy of less than 16 milliseconds.

While process 300 has been described herein from the perspective of actions undertaken by one device of a pair of collaborating video capture devices (e.g., device 102), the other video capture device (e.g., device 104) may undertake similar operations to those described above. Thus, in various implementations, device 104 may capture a video sequence in response to start and stop control messages received from device 102, may receive a video sequence captured by device 102, and may then use the clock offset it has determined (e.g., using Eq. 2) to synchronize the two video sequences as described above.

In addition, in accordance with the present disclosure, each collaborating video capture device may also independently measure the combined capture delay introduced by the device platform, the device's operating system (OS) software, and the device's video capture software. For example, after receiving an acknowledgment to a video trigger command and after the user presses a start button, the device may transmit a start command. The receiving device may record the ToA of the start command, the delay introduced by the device's auto-focus, and the delay introduced by generating one frame. Thus, the receiving video capture device may estimate frame transmission delay by calculating: ToA−ToD+time_offset. The delay introduced locally may then be estimated as:

local_delay=delay_auto_focus+delay_frame_generation (Eq. 3)

Thus, by comparing the local delays recorded at different devices, a master device may estimate the timing offset between the start of video capture at the master device or server and the start of video capture at the slave device or client.

While implementation of example processes 300 and 6110, as illustrated in FIGS. 3 and 6, may include the undertaking of all blocks shown in the order illustrated, the present disclosure is not limited in this regard and, in various examples, implementation of processes 300 and 600 may include the undertaking only a subset of the blocks shown and/or in a different order than illustrated.

In addition, any one or more of the blocks of FIGS. 3 and 6 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 3 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

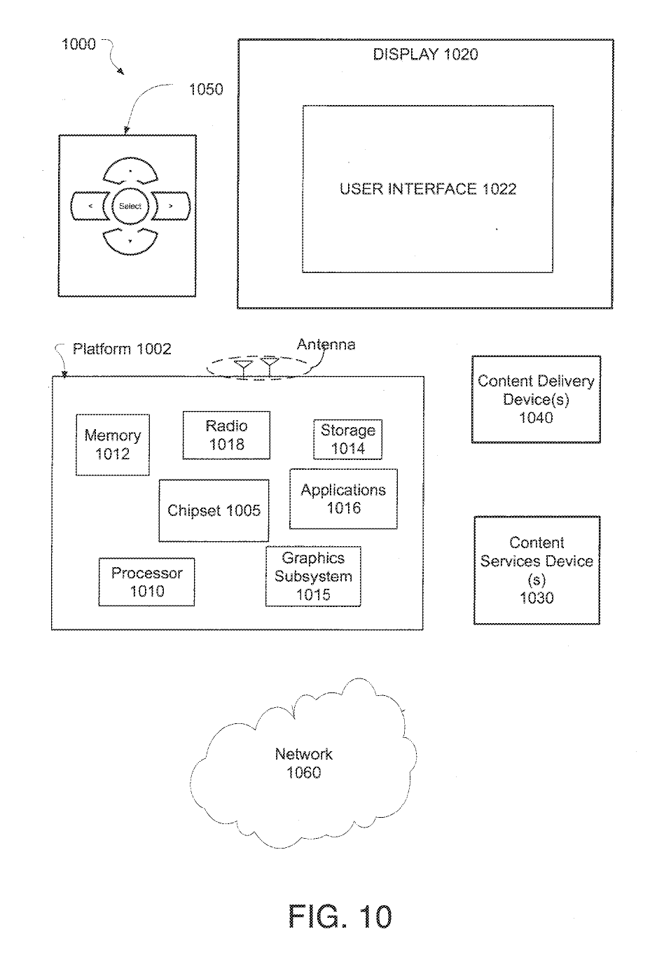

FIG. 10 illustrates an example system 1000 in accordance with the present disclosure. In various implementations, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1000 includes a platform 1002 coupled to a display 1020. Platform 1002 may receive content from a content device such as content services device(s) 1030 or content delivery device(s) 1040 or other similar content sources. A navigation controller 1050 including one or more navigation features may be used to interact with, for example, platform 1002 and/or display 1020. Each of these components is described in greater detail below.

In various implementations, platform 1002 may include any combination of a chipset 1005, processor 1010, memory 1012, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1010 may be dual-core processor(s), dual-core mobile processor(s), and so forth.

Memory 1012 may be implemented as a volatile memory device such as but not limited to, a Random Access Memory (RAM), Dynamic Random. Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPI) or a visual processing unit (VPU), for example. An analog or digital interface may be used to communicatively couple graphics subsystem 1015 and display 1020. For example, the interface may be any of a High-Definition Multimedia interface, DisplayPort, wireless HDMI, and/or wireless HD compliant techniques. Graphics subsystem 1015 may be integrated into processor 1010 or chipset 1005. In some implementations, graphics subsystem 1015 may be a stand-alone card communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In a further embodiments, the functions may be implemented in a consumer electronics device.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television type monitor or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In various implementations, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In various implementations, content services device(s) 1030 may include a cable television box, personal computer, network telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In various embodiments, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be replicated on a display display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022, for example. In various embodiments, controller 1050 may not be a separate component but may be integrated into platform 1002 and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 even when the platform is turned “off”. In addition, chipset 1005 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 may be an integrated unit. Display 1020 and content service device(s) 1030 may be integrated, or display 1020 and content delivery device(s) 1040 may be integrated, for example. These examples are not meant to limit the present disclosure.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RE spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit, board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

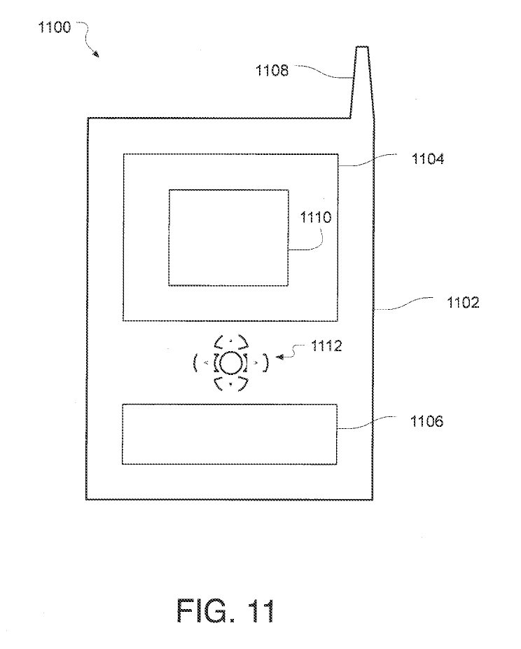

As described above, system 1000 may be embodied in varying physical styles or form factors. FIG. 11 illustrates implementations of a small form factor device 1100 in which system 1000 may be embodied. In various embodiments, for example, device 1100 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 1100 may include a housing 1102, a display 1104, an input/output (I/O) device 1106, and an antenna 1108. Device 1100 also may include navigation features 1112. Display 1104 may include any suitable display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, and so forth. Information also may be entered into device 1100 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-30. (canceled)

31. A computer-implemented method, comprising:
at a first video capture device:
determining a clock offset between the first video capture device and a second video capture device;
sending a start command to the second video capture device;
capturing a first video sequence of a scene;
sending a stop command to the second video capture device;
sending a video file transfer command to the second video capture device;
receiving a second video sequence of the scene, the second video sequence having been captured by the second video capture device in response to the start and stop commands; and
using the clock offset to synchronize the first video sequence to the second video sequence.

32. The method of claim 31, wherein determining the clock offset comprises performing a synchronization protocol, the synchronization protocol including:
transmitting a first message to the second video capture device, the first message including a first time stamp;
receiving a second message from the second video capture device, the second message including a second time stamp and a third time stamp; and
generating a fourth time stamp in response to receiving the second message.

33. The method of claim 32, wherein the first video capture device includes a first clock, wherein the second video capture device includes a second clock different than the first clock, wherein the first clock generates the first and fourth time stamps, and wherein the second clock generates the second and third time stamps.

34. The method of claim 32, wherein the first time stamp comprises a time of transmission of the first message by the first video capture device, wherein the second time stamp comprises a time of receipt of the first message by the second video capture device, wherein the third time stamp comprises a time of transmission of the second message by the second video capture device, and wherein the fourth time stamp comprises a time of receipt of the second message by the first video capture device.

35. The method of claim 32, further comprising:
determining the clock offset in response to the first, second, third, and fourth time stamps.

36. The method of claim 35, wherein a difference between the second time stamp and the first time stamp comprises a first timing offset value, wherein a difference between the fourth time stamp and the third time stamp comprises a second timing offset value, and wherein determining the clock offset in response to the first, second, third, and fourth time stamps comprises subtracting the second timing offset value from the first timing offset value.

37. The method of claim 32, further comprising:
transmitting a third message to the second video capture device, the third message including the fourth time stamp.

38. The method of claim 32, wherein performing the synchronization protocol comprises repeatedly performing the synchronization protocol.

39. The method of claim 31, wherein receiving the second video sequence comprises receiving metadata including a start time of the second video sequence, and wherein using the clock offset to synchronize the first video sequence to the second video sequence comprises using the clock offset, a start time of the first video sequence, and the start time of the second video sequence to synchronize the first video sequence to the second video sequence.

40. The method of claim 39, wherein the metadata includes a frame rate of the second video sequence, and wherein using the clock offset to synchronize the first video sequence to the second video sequence comprises using the clock offset, a start time of the first video sequence, the start time of the second video sequence, the frame rate of the first video sequence, and the frame rate of the second video sequence to synchronize the first video sequence to the second video sequence.

41. The method of claim 39, wherein each image frame of the first video sequence includes a time stamp, wherein each image frame of the second video sequence includes a time stamp, and wherein using the clock offset to synchronize the first video sequence to the second video sequence comprises using the clock offset, the time stamps of images in the first video sequence, and the time stamps of images in the second video sequence to synchronize the first video sequence to the second video sequence.

42. An article comprising a computer program product having stored therein instructions that, if executed, result in:
at a first video capture device:
determining a clock offset between the first video capture device and a second video capture device;
sending a start command to the second video capture device;
capturing a first video sequence of a scene;
sending a stop command to the second video capture device;
sending a video file transfer command to the second video capture device;
receiving a second video sequence of the scene, the second video sequence having been captured by the second video capture device in response to the start and stop commands; and
using the clock offset to synchronize the first video sequence to the second video sequence.

43. The article of claim 42, wherein determining the clock offset comprises performing a synchronization protocol, the synchronization protocol including:
transmitting a first message to the second video capture device, the first message including a first time stamp;
receiving a second message from the second video capture device, the second message including a second time stamp and a third time stamp; and
generating a fourth time stamp in response to receiving the second message.

44. The article of claim 43, wherein a difference between the second time stamp and the first time stamp comprises a first timing offset value, wherein a difference between the fourth time stamp and the third time stamp comprises a second timing offset value, and wherein determining the clock offset in response to the first, second, third, and fourth time stamps comprises subtracting the second timing offset value from the first timing offset value.

45. The article of claim 42, wherein receiving the second video sequence comprises receiving metadata including a start time of the second video sequence, and wherein using the clock offset to synchronize the first video sequence to the second video sequence comprises using the clock offset, a start time of the first video sequence, and the start time of the second video sequence to synchronize the first video sequence to the second video sequence.

46. A device, comprising:
a processor configured to:
determine a clock offset between the first video capture device and a second video capture device;
send a start command to the second video device;
capture a first video sequence of a scene;
send a stop command to the second video capture device;
send a video file transfer command to the second video capture device;
receive a second video sequence of the scene, the second video sequence having been captured by the second video capture device in response to the start and stop commands; and
use the clock offset to synchronize the first video sequence to the second video sequence.

47. The device of claim 46, wherein to determine the clock offset the processor is configured to:
transmit a first message to the second video capture device, the first message including a first time stamp;
receive a second message from the second video capture device, the second message including a second time stamp and a third time stamp; and
generate a fourth time stamp in response to receiving the second message.

48. The device of claim 47, wherein a difference between the second time stamp and the first time stamp comprises a first timing offset value, wherein a difference between the fourth time stamp and the third time stamp comprises a second timing offset value, and wherein determining the clock offset comprises subtracting the second timing offset value from the first timing offset value.

49. The device of claim 46, wherein receiving the second video sequence comprises receiving metadata including a start time of the second video sequence, and wherein using the clock offset to synchronize the first video sequence to the second video sequence comprises using the clock offset, a start time of the first video sequence, and the start time of the second video sequence to synchronize the first video sequence to the second video sequence.

50. A system comprising:
a first video capture device including:
an imaging module; and
a processor coupled to the imaging module, the processor to:
determine a clock offset between the first video capture device and a second video capture device;
send a start command to the second video capture device;
capture a first video sequence of a scene using the imaging module;
send a stop command to the second video capture device;
send a video file transfer command to the second video capture device;
receive a second video sequence of the scene, the second video sequence having been captured by the second video capture device in response to the start and stop commands; and
use the clock offset to synchronize the first video sequence to the second video sequence.

51. The system of claim 50, wherein to determine the clock offset the processor is configured to:
transmit a first message to the second video capture device, the first message including a first time stamp;
receive a second message from the second video capture device, the second message including a second time stamp and a third time stamp; and
generate a fourth time stamp in response to receiving the second message.

52. The system of claim 51, wherein a difference between the second time stamp and the first time stamp comprises a first timing offset value, wherein a difference between the fourth time stamp and the third time stamp comprises a second timing offset value, and wherein determining the clock offset comprises subtracting the second timing offset value from the first timing offset value.

53. The system of claim 50, wherein receiving the second video sequence comprises receiving metadata including a start time of the second video sequence, and wherein using the clock offset to synchronize the first video sequence to the second video sequence comprises using the clock offset, a start time of the first video sequence, and the start time of the second video sequence to synchronize the first video sequence to the second video sequence.
